(19) United States
(12) Patent Application Publication
(10) Pub. No.: US 2006/0030983 A1
(43) Pub. Date: Feb. 9, 2006

(54) Apparatus and methods for facilitating vehicle maintenance

(75) Inventor: Dexter V. Bautista, Daytona Beach, FL (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/030,005

(22) Filed: Jan. 5, 2005

Related U.S. Application Data
(60) Provisional application No. 60/534,399, filed on Jan. 6, 2004.

(51) Int. Cl. G06F 19/00

(52) U.S. Cl. 701/33; 701/29; 340/438

(57) ABSTRACT

A system for facilitating maintenance of one or more vehicles. On each vehicle, a control subsystem includes one or more controllers that obtain information pertaining to a condition of the vehicle. A base computer communicates wirelessly with the control subsystem. The base computer and controller(s) interpret the information. This system allows the performance of a fleet of vehicles to be monitored automatically.

### RELATED APPLICATIONS

This application is a nonprovisional of U.S. Provisional Patent Application No. 60/534,399 filed on Jan. 6, 2004. The disclosure of the above application is incorporated herein by reference.

### FIELD OF THE INVENTION

The present invention relates to vehicle maintenance and, more particularly, to facilitating maintenance of one or more vehicles using data obtained from the vehicle(s) and sent wirelessly to a base computer.

### BACKGROUND OF THE INVENTION

On many golf courses one is likely to find a fleet of golf cars that are used intensively and by many different types of drivers. Even when driven in accordance with the rules of a course, golf cars eventually need maintenance. It can save money, time and aggravation when a potentially debilitating condition on a car is noted and fixed before it can cause the car to break down or otherwise operate improperly. Keeping all cars of a fleet in good running condition can be difficult and expensive, particularly when the fleet is large and/or the course conditions are such that the cars may be subjected to heavy wear and tear during play.

### SUMMARY OF THE INVENTION

The present invention, in one embodiment, is directed to a system for facilitating maintenance of one or more vehicles. On each vehicle, a control subsystem includes one or more controllers configured to obtain information pertaining to at least one condition of the vehicle. A base computer is configured to communicate wirelessly with the control subsystem. The base computer is further configured with the one or more controllers to interpret the information.

Further areas of applicability of the present invention will become apparent from the detailed description provided hereinafter. It is to be understood that the detailed description and specific examples, while indicating various embodiments of the present invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an illustration of a system for facilitating maintenance of one or more vehicles according to one embodiment of the present invention;

FIG. 2 is a diagram of an embodiment of a control subsystem;

FIG. 3 is a controller fault memory map in one embodiment;

FIG. 4 is a diagram of an embodiment of a control subsystem;

FIG. 5 is an illustration of an embodiment of a recommended maintenance report;

FIG. 6 is an illustration of an embodiment of a fleet statistics report; and

FIG. 7 is an illustration of an embodiment of a display of vehicle faults relative to a course map.

### DETAILED DESCRIPTION OF EMBODIMENTS OF THE INVENTION

The following description of embodiments of the present invention is merely exemplary in nature and is in no way intended to limit the invention, its application, or uses. Although embodiments of the present invention are described with reference to a golf car and in the context of maintaining a fleet of golf cars for use on a golf course, the invention is not so limited. Embodiments also are contemplated in connection with utility vehicles, vehicles in a factory environment, and other types of vehicles and uses.

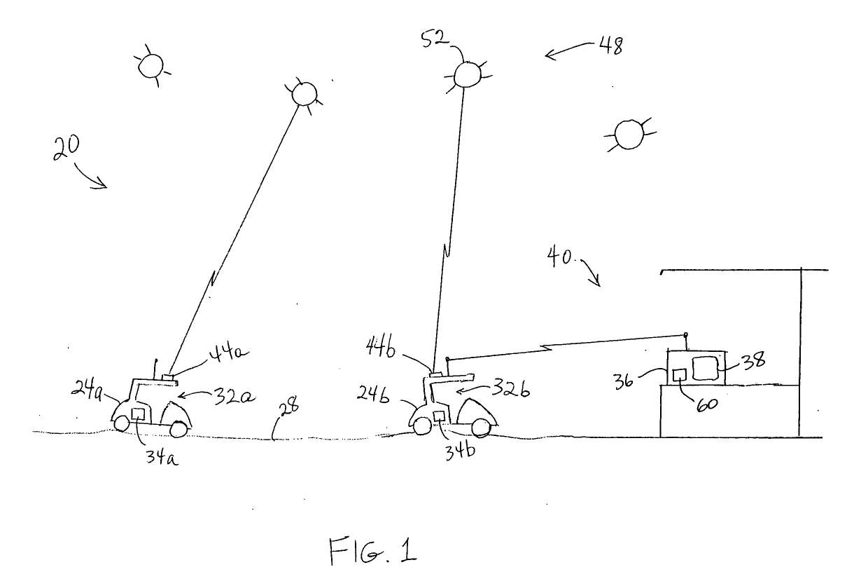

FIG. 1 illustrates a system 20 for facilitating maintenance of one or more vehicles, for example, one or more golf cars 24. Two electrically or gas powered cars 24a and 24b are shown in FIG. 1. The system 20 may be used within a predefined area, for example, a golf course 28. Each vehicle 24 has a control subsystem, indicated generally as 32 and further described below. A base computer 36 having an optional display 38 is located, for example, in a vehicle holding area 40 of the course 28. In another embodiment, the system 20 is included in a golf course management system and the base computer 36 is located in a course clubhouse. The computer 36 is configured to communicate wirelessly with the car control subsystems 32a and 32b, each of which has one or more controllers 34.

The controller 34 of a vehicle 24 are configured to obtain information pertaining to at least one condition of the vehicle 24 as further described below. The base computer 36 is configured with the controller 34 to interpret the information. For example, based on such information, the system 20 may recommend that one or more maintenance actions be performed for at least one vehicle 24. As another example, the system 20 may cause statistical or other data relating to one or more vehicles 24 to be displayed on the display 38 as further described below. Additionally or alternatively, the base computer 36 may include a printer (not shown) and/or other device via which data relating to the vehicle 24 may be output.

While a vehicle 24 is traveling out of range of wireless communication with the base computer 36, information obtained by the vehicle controller 34, as described further below, may be stored in the vehicle subsystem 32. As shown in FIG. 1, the vehicle 24b is within range of wireless communication with the base computer 36. Data synchronization thus may take place between the vehicle subsystem 32b and the base computer 36. Specifically, information updates are exchanged, and information conflicts are resolved, between the vehicle subsystem 32b and the base computer 36. In another embodiment, for example, wherein the base computer 36 is included in course management system, the vehicles 24 are constantly within range of wireless communication with the base computer 36. In such case, synchronization may take place continuously while a car 24 is in use on the course 28.

In the embodiment shown in FIG. 1, the vehicle control subsystems 32a and 32b include positioning devices 44a and 44b. Each of the devices 44 communicates with a positioning system, indicated generally as 48, to identify a current position of the corresponding vehicle 24. The positioning system 48 is, for example, a satellite positioning system such as the United States government-controlled Global Positioning System (GPS). Other and additional positioning systems, such as differential GPS, long range navigation (LORAN-G), or other triangulation systems, may be used in other embodiments, however, to provide coordinates and/or other information identifying positions of the vehicles 24. In the embodiment shown in FIG. 1, the devices 44 receive signals from GPS satellites 52. Each device 44 uses signals from three of the satellites 52 to measure geographical location and identify latitudes and longitudes of the corresponding vehicle 24. Signals from a fourth satellite 52 are used to measure time, as known in the art. When a position of a vehicle 24 is identified in the foregoing manner, the control subsystem 32 of the vehicle may save and/or transmit the position to the base computer 36 for use as further described below. The computer 36 may use a digital map 60 to determine a location on the golf course 28 corresponding to the identified position of the vehicle.

The computer 36 may refer to the map 60 and to car position information to display, e.g., on the display unit 38, one or more cars 24 relative to the course 28. Systems are known whereby positions of golf cars on a golf course can be determined and displayed on a base computer. One such system has been described in Rudow et al., U.S. Pat. No. 6,525,690, the disclosure of which is incorporated herein by reference.

The system 20 can be configured to relate geographic positions of the vehicle(s) 24 to locations on the golf course 28 in the following exemplary manner. The golf course 28 is surveyed, and data obtained from the survey is processed, to configure the digital map 60. The map 60 includes, for example, positional coordinates and/or positional vectors that delineate or otherwise describe surveyed areas and features of the course 28. Such features and/or surveyed areas may include but are not limited to car paths, greens, fairways, bunkers, bodies of water, fences, parking lots, practice tees, staging areas, car barns and grades such as steep hills and/or dangerous terrain. For a given vehicle 24, the base computer 36 correlates position information provided by the vehicle control subsystem 32 with geographic locations described by the digital map 60. Embodiments also are contemplated, however, that do not include positioning devices.

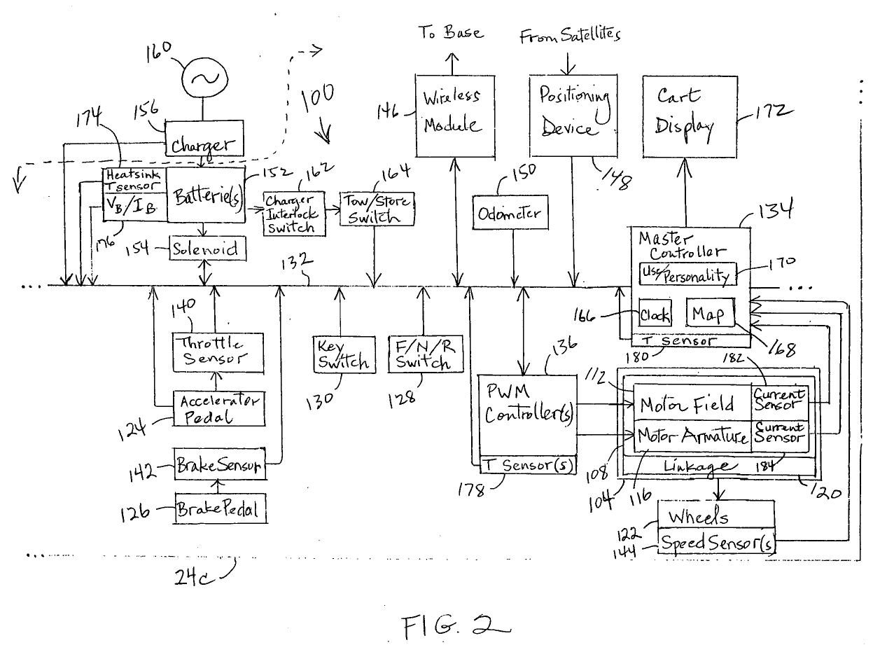

Another embodiment of a control subsystem for a vehicle 24 is indicated generally by reference number 100 in FIG. 2. The subsystem 100 is included in an electrically powered vehicle 24c. A vehicle drive train 104 includes a motor 108 operable via currents through a field 112 and an armature 116. Linkage 120, which transmits power from the motor 108 to vehicle wheels 122, includes a connection between a transaxle pinion shaft (not shown) and a shaft of the motor 108. A user may control the vehicle 24c using an accelerator pedal 124, a brake pedal 126, a gear shift switch 128 that allows the user to shift among forward, neutral and reverse gears, a keyed switch 130 that allows the user to enable or disable power to the drive train 104, and a steering wheel (not shown).

The subsystem 100 includes a communications bus 132. In other embodiments, other communications topologies, including but not limited to star and/or ring topologies, could be used. In yet another embodiment, the subsystem 100 includes a wireless topology implemented, for example, using a Bluetooth® protocol. A master controller 134 is connected by the bus 132 with one or more pulse-width modulation (PWM) controllers 136 that provide duty cycles to the field 112 and armature 116.

The master controller 134 receives various digital inputs pertaining to the vehicle 24c. For example, the master controller 134 receives input signals from a throttle sensor 140 activated by the accelerator pedal 124 and from a brake pedal sensor 142 activated by the brake pedal 126. The master controller 134 also receives signal input from the gear switch 128, key switch 130, and one or more wheel speed sensors 144 attached, for example, to axle(s) (not shown) supporting vehicle wheels 122. A wireless module 146 transmits and receives communications to and from the base computer 36 (shown in FIG. 1). The wireless module 146, a positioning device 148 and an odometer 150 are linked to the bus 132.

A battery 152 is connected via a solenoid switching device 154 to the bus 132. A charger 156 can be attached to charge the battery 152, for example, from a power outlet 160. A charger interlock switch 162 and tow/store switch 164 are connected between the battery 152 and the bus 132. The charger interlock switch 162 prevents the vehicle from being started while the charger 156 is connected to the power source 160. The tow/store switch allows the user to switch off current from the battery, for example, during extended periods of nonuse.

The master controller 134 includes a clock 166 and a map 168 as previously described with reference to FIG. 1. The controller 134 also has access to data 170 descriptive, for example, of various car uses and/or driver personalities. Based on the data 170, the controller may vary parameters such as maximum forward and/or reverse speeds of the vehicle 24c. The controller 134 is linked to a display 172, e.g., a video monitor mounted in the vehicle 24c so as to be visible by a driver of the vehicle.

It should be understood generally that although one master controller and one or more PWM controllers are shown in FIG. 2, other numbers of controllers, including a single controller, could be used. Additionally, it should be understood that the terms “controller” and “computer” may be used interchangeably herein and can include but are not limited to processors, microprocessors, microcontrollers, microcomputers, personal computers, personal electronic devices and the like.

A plurality of sensors and/or sensing circuits provide input to the master controller 134, from which various data can be obtained pertaining to at least one condition of the vehicle 24c. For example, while the battery 152 is being charged by the charger 156, the charger 156 determines the state of charge of the battery 152. The charger 156 may also track output current to the battery, ampere hours returned to the battery, battery voltage, and recharge time. During recharging of the battery 152, the charger 156 can be linked to the bus 132 or directly to the master controller 134. Thus, while the charger 156 is linked to the subsystem 100, the foregoing information can be sent to the master controller 134.

A heat sink sensing circuit 174 senses heat from the battery 152 and sends information pertaining to battery temperature to the controller 134. A voltage and/or current sensing circuit 176 sends data pertaining to battery terminal voltage and/or current to the controller 134. One or more temperature sensors 178 send information pertaining to temperature of the one or more PWM controllers 136 to the master controller 134. A temperature sensor 180 sends to the master controller 134 temperature information pertaining to the master controller 134. Current sensing circuits 182 and 184 sense currents in the field 112 and armature 116 and are linked to the master controller 134 and/or to the bus 132. A brake pedal 124 outputs a signal to brake sensor 142. Brake sensor 142 in turn generates a signal onto bus 132 that varies in accordance with the position of brake pedal 14.

The master controller 134 periodically polls the various foregoing inputs and processes and stores various input values in memory. The controller 134 also sets and stores a fault code when a fault is detected from the various inputs. A fault can be time- and/or date-stamped by the master controller 134. Additionally or alternatively, a vehicle position on the course 28 at the time of fault detection can be identified by the positioning device 148 and stored with the fault in the controller 134.

In an embodiment wherein the vehicle 24c is in continuous wireless communication with the base station 36, if a fault occurs while the car is on the course 28, the controller 134 may cause the wireless module 146 to transmit a message to the base computer 36 so as, for example, to alert course personnel to a need for immediate maintenance or repair of a condition indicated by the fault. Additionally or alternatively, the controller 134 may cause to be displayed on the vehicle display 172 a message to alert the driver that maintenance or repair is needed. Such a message may be displayed based on a location of the vehicle as determined by the positioning device 148. For example, when the vehicle 24c arrives in the vehicle holding area 40, the subsystem 100 may display a message instructing the driver to drive the vehicle 24c to a maintenance area for repair.

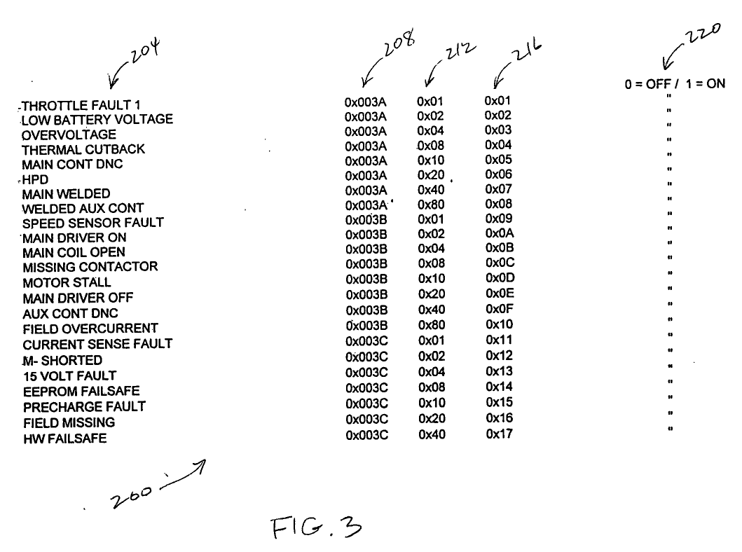

An exemplary master controller fault memory map is indicated generally in FIG. 3 by reference number 200. For each fault indicated in controller memory, the map 200 shows a description 204, fault address 208 and bit position(s) 212, identification number 216, and possible settings 220. When the vehicle 24c control subsystem 100 becomes synchronized with the base computer 36, the subsystem 100 transmits, for example, values from controller memory locations indicated by the controller fault memory map 200 to the base computer 36. The master controller 134 and/or the base computer 36 are configured to interpret fault data and other information obtained from the foregoing inputs in various and useful ways, as further described below.

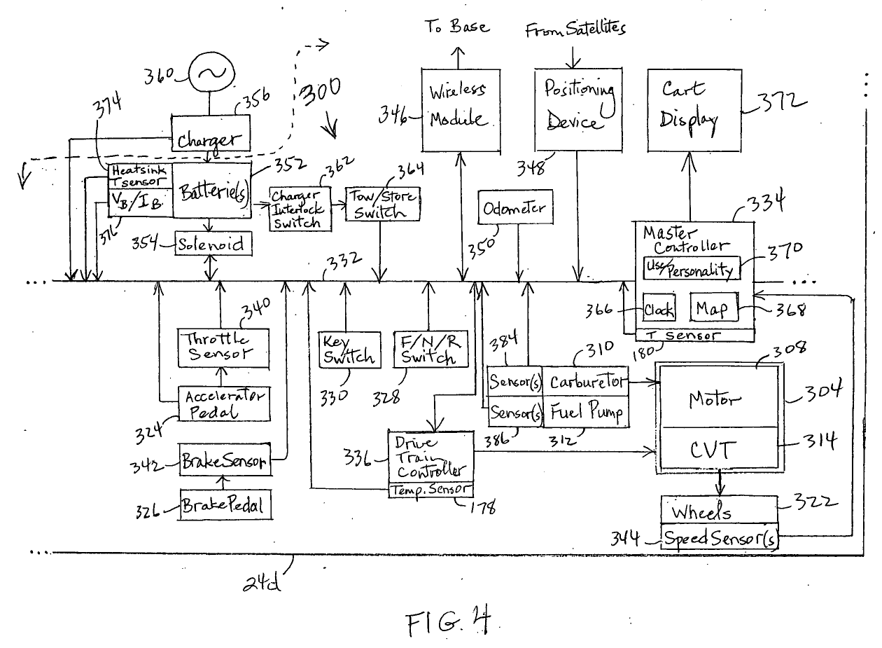

Another embodiment of a vehicle control subsystem is indicated generally by reference number 300 in FIG. 4. The subsystem 300 is included in a gasoline-powered vehicle 24d. A vehicle drive train 304 includes a motor 308 fueled via a carburetor 310 and fuel pump 312. A continuously variable transmission (CVT) 314 transmits power from the motor 308 to vehicle wheels 322. A user may control the vehicle 24d using an accelerator pedal 324, a brake pedal 326, a gear shift switch 328 that allows the user to shift among forward, neutral and reverse gears, a keyed switch 330 that allows the user to enable or disable power to the drive train 308, and a steering wheel (not shown).

The subsystem 300 includes a communications bus 332. In other embodiments, other communications topologies, including but not limited to star and/or ring topologies, could be used. In yet another embodiment, the subsystem 300 includes a wireless topology implemented, for example, using a Bluetooth® protocol. A master controller 334 is connected by the bus 332 with a drive train controller 336 that controls the drive train 308.

The master controller 334 receives various digital inputs pertaining to the vehicle 24d. For example, the master controller 334 receives input signals from a throttle sensor 340 activated by the accelerator pedal 324 and from a brake pedal sensor 342 activated by the brake pedal 326. The master controller 334 also receives signal input from the gear switch 328, key switch 330, and one or more wheel speed sensors 344 attached, for example, to axle(s) (not shown) supporting vehicle wheels 322. A wireless module 346 transmits and receives communications to and from the base computer 36 (shown in FIG. 1). The wireless module 346, a positioning device 348 and an odometer 350 are linked to the bus 332.

A battery 352 is connected via a solenoid switching device 354 to the bus 332. A charger 356 can be attached to charge the battery 352, for example, from a power outlet 360. A charger interlock switch 362 and tow/store switch 364 are connected between the battery 352 and the bus 332. The charger interlock switch 362 prevents the vehicle from being started while the charger 356 is connected to the power source 360. The tow/store switch 364 allows the user to switch off current from the battery, for example, during extended periods of nonuse.

The master controller 334 includes a clock 366 and a map 368 as previously described with reference to FIG. 1. The controller 334 also includes data 370 descriptive, for example, of various car uses and/or driver personalities. Based on the data 370, the controller may vary parameters such as maximum forward and/or reverse speeds of the vehicle 24d. The controller 334 is linked to a display 372, e.g., a video monitor mounted in the vehicle 24d so as to be visible by a driver of the vehicle. It should be understood that although one master controller and one drive train controller are shown in FIG. 4, other numbers of controllers, including a single controller, could be used.

A plurality of sensors and/or sensing circuits provide input to the master controller 334, from which various data can be obtained pertaining to at least one condition of the vehicle 24d. For example, while the battery 352 is being charged by the charger 356, the charger determines the state of charge of the battery 352. The charger 356 may also track output current to the battery, ampere hours returned to the battery, battery voltage, and recharge time. During recharging of the battery 352, the charger 356 can be linked to the bus 332 or directly to the master controller 334. Thus, while the charger 356 is linked to the subsystem 300, the foregoing information can be sent to the master controller 334.

A heat sink sensing circuit 374 senses heat from the battery 352 and sends information pertaining to battery temperature to the controller 334. A voltage and/or current sensing circuit 376 sends data pertaining to battery terminal voltage and/or current to the controller 334. One or more temperature sensors 378 send information pertaining to temperature of the drive train controller 336 to the master controller 334. A temperature sensor 380 sends to the master controller 334 temperature information pertaining to the master controller 334. Sensors 384 and 386 for the carburetor 310 and fuel pump 132 and are linked to the master controller 334 and/or to the bus 332. The master controller stores information from the foregoing components, transmits such information to the base computer 36 and/or displays information to a driver of the vehicle 24d, as previously described with reference to FIGS. 2 and 3. The master controller 334 and/or the base computer 36 are configured to interpret the information obtained from the foregoing inputs in various and useful ways, as further described below.

Referring again to FIG. 2, during periods when the vehicle 24c is in use, the master controller 134 uses the clock 166 and the key switch 130 to keep track of hours of operation of the car 24c. The odometer 150 is used to keep track of miles driven. The hours of operation and/or miles driven may be transmitted to the base computer 36, which may keep track of the foregoing values in various ways. If a fault occurs while the car 24c is in use, the controller 134 may cause the wireless module to transmit a message to the base computer 36. The controller may also reduce speed of the vehicle, for example, by changing a duty map in the PWM controller 136 for current through the field 112, and thereby force the vehicle 24c to “limp home” to the holding area 40.

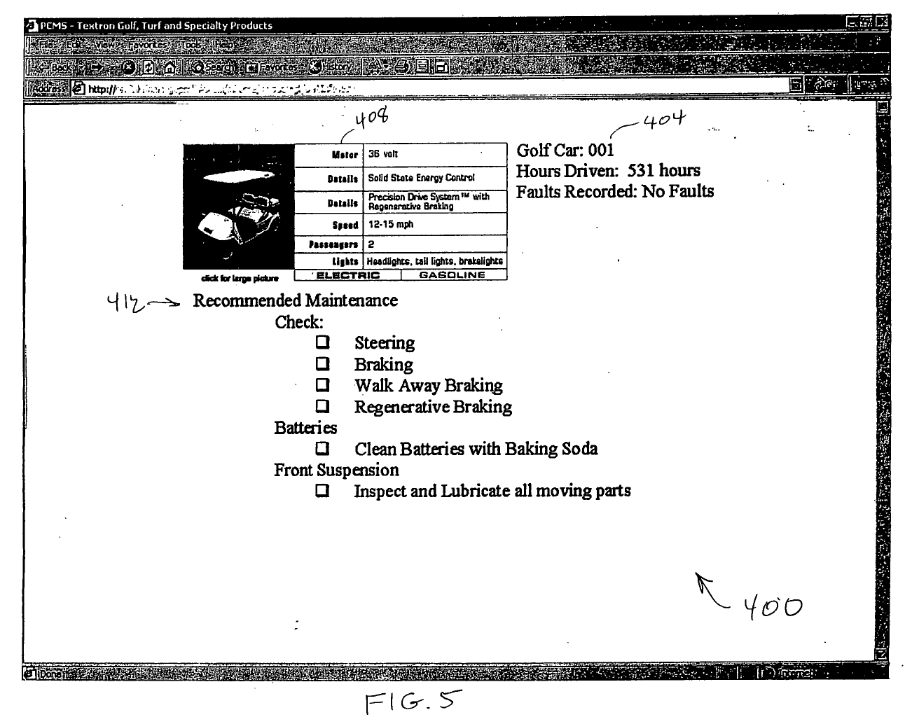

It can be appreciated that information obtained by a vehicle subsystem as described above can be used in many ways. For example, referring to FIGS. 1 and 2, the base computer may use the information transmitted from the vehicle 24c to generate a recommended maintenance report, an embodiment of which is indicated generally in FIG. 5 by reference number 400. The report 400 indicates a unique identification number 404 for the car 24c, which is stored in the vehicle 24c subsystem master controller 134. Also displayed are a car summary 408 indicating various details describing the vehicle 24c. A list 412 of recommended maintenance items is compiled by the base computer 36 and/or the master controller 134 based on the information obtained by the master controller 134 pertaining to condition(s) of the vehicle 24c.

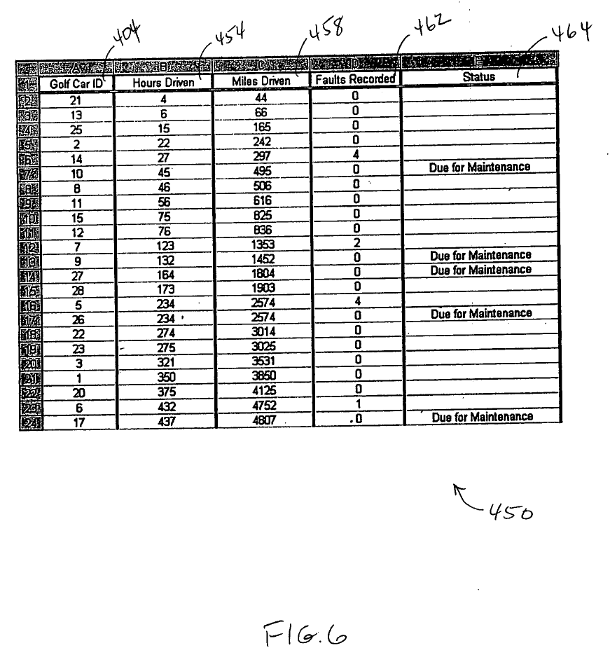

Additionally or alternatively, the system 20 can compile and display information pertaining to a plurality of vehicles 24. For example, FIG. 6 illustrates an exemplary fleet statistics report 450. For each car 24, the report 450 lists the identification number 404, hours driven 454, miles driven 458, faults recorded 462, and a maintenance status 464. It can be understood that a variety of statistics can be compiled over time and sorted and displayed in various ways to facilitate maintenance of the vehicles 24.

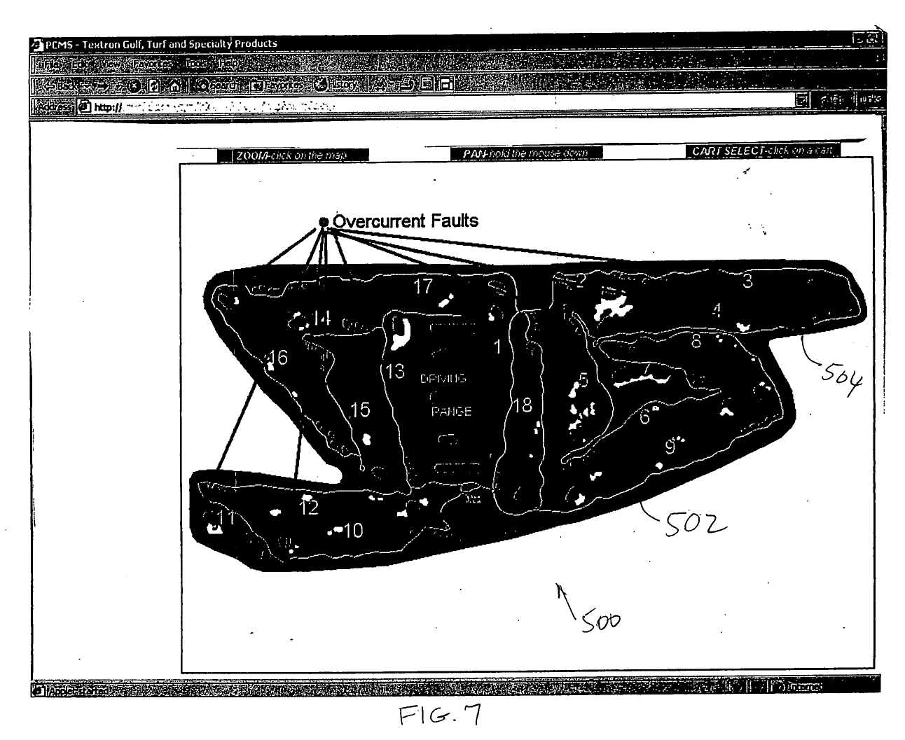

Another exemplary embodiment of a report displayed, for example, on the base computer display 38, is indicated generally in FIG. 7 by reference number 500. The report 500 includes a display 502 of the map 60 of the course 28, upon which are superimposed icons 504 representing car faults detected and location-identified by the system 20 as previously described. A user may mouse-click on an icon 504 to display information (not shown in FIG. 7) pertaining to the vehicle 24 that experienced the fault represented by the icon.

Information obtained by the system 20 can be used diagnostically in many ways. For example, current draw of a particular vehicle 24c can be obtained in terms of ampere hours per round of golf play. The current draw may be compared to a factory specification, to historical data, and/or to a fleet average current draw. An unusual amount of current draw could indicate, for example, a need to adjust brake pressure, a need to fill low tires, and/or a need to replace a defective motor.

It can be appreciated that a variety of reports can be provided via the system 20. For example, automatic fleet rotation schedules can be generated based on vehicle maintenance recommendations, and battery life reports can be generated based on charger and battery information obtained as previously described with reference to FIGS. 2 through 4. Information can be interpreted in various ways to provide troubleshooting assistance with respect to a vehicle 24. For example, referring to FIGS. 2 and 3, for a particular active fault code, the base computer 36 may transmit to the master controller 134, for display on the display 172, a detailed description of the fault and what action to take to correct the fault.

When the system 20 is used to track the condition of vehicles in a fleet, usage of the vehicles over time can easily be evened out, thus promoting even aging of the fleet. The foregoing system can also be used to facilitate warranty protection of vehicles and vehicle components. Since items such as batteries and controllers tend to be expensive, it can be beneficial to use the foregoing system to track their condition. A user can use the foregoing system to detect when a component is not performing adequately and thus might be a candidate for replacement under an applicable warranty.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system for facilitating maintenance of one or more vehicles comprising:
on each vehicle, a control subsystem having one or more controllers configured to obtain information pertaining to at least one condition of the vehicle; and
a base computer configured to communicate wirelessly with the control subsystem, the base computer further configured with the one or more controllers to interpret the information.

2. The system of claim 1 wherein configured to interpret the information comprises configured to recommend maintenance for at least one of the one or more vehicles based on the information.

3. The system of claim 1 wherein the base computer comprises a display, and wherein configured to interpret the information comprises configured to display on the display at least one datum relating to at least one of the one or more vehicles.

4. The system of claim 1 wherein the base computer is further configured to transmit a message to the control subsystem based on the interpreted information.

5. The system of claim 1 wherein the control subsystem is further configured to transmit a message to the base computer based on the interpreted information.

6. The system of claim 1 wherein the control subsystem comprises at least one of a speed sensor, a drive train, a power source, a gearshift switch, a throttle sensor, a key switch, and a brake sensor, the one or more controllers configured to obtain at least part of the information from the at least one of a speed sensor, a current sensor, a temperature sensor, a drive train, a power source, a gearshift switch, a throttle sensor, a key switch, and a brake sensor.

7. The system of claim 1 wherein the control subsystem comprises a motor having an armature winding and a field winding, the control subsystem further comprising at least one current sensor that senses current through at least one of the windings;
the one or more controllers configured to obtain at least part of the information from the at least one current sensor.

8. The system of claim 1 wherein the control subsystem comprises at least one temperature sensor that senses temperature of the one or more controllers;
the one or more controllers configured to obtain at least part of the information from the at least one temperature sensor.

9. The system of claim 1 wherein the control subsystem comprises at least one speed sensor that senses speed of the vehicle;
the one or more controllers configured to obtain at least part of the information from the at least one speed sensor.

10. The system of claim 1 wherein the control subsystem comprises a battery that provides power to the vehicle, the control subsystem further configured to measure at least one of a voltage across the battery and a current through the battery;
the one or more controllers configured to obtain at least part of the information from at least one of the battery voltage and battery current.

11. The system of claim 1 wherein the control subsystem comprises a battery that provides power to the vehicle, the system further comprising a charger that charges the battery, the one or more controllers further configured to use an output of the charger to determine a state of charge of the battery.

12. The system of claim 1 wherein the control subsystem comprises a positioning device configured to identify a position of the vehicle, the one or more controllers configured to obtain at least part of the information from the positioning device.

13. The system of claim 1 wherein the one or more vehicles comprise one or more golf cars.

14. A method of facilitating maintenance of a vehicle, the method comprising:
obtaining data pertaining to at least one condition of the vehicle;
transmitting the data wirelessly to a base computer; and
interpreting the data;
wherein the obtaining and transmitting are performed using a control subsystem of the vehicle, and the interpreting is performed using the base computer and one or more controllers of the vehicle control subsystem.

15. The method of claim 14 further comprising recommending maintenance for the vehicle based on the data.

16. The method of claim 14 further comprising obtaining data pertaining to one or more conditions of a plurality of vehicles, wherein the obtaining and transmitting are performed using a control subsystem of each of the vehicles;
the method further comprising statistically analyzing the data.

17. The method of claim 14 wherein obtaining data pertaining to at least one condition comprises polling at least one of a speed sensor, a drive train controller, a power source, a gearshift switch, a throttle sensor, a key switch, and a brake sensor.

18. The method of claim 14 further comprising identifying a position of the vehicle; and
relating the position to at least one of the data.

19. A system for facilitating maintenance of one or more vehicles comprising:
a base computer; and
one or more control subsystems, each control subsystem configured in a corresponding one of the one or more vehicles and further configured to communicate wirelessly with the base station;
each control subsystem comprising one or more controllers configured to obtain data relating to one or more conditions of the one or more vehicles and transmit the data to the base computer.

20. The system of claim 19 wherein the one or more controllers obtain at least part of the data from a battery linked to the one or more controllers.

21. The system of claim 19 wherein the one or more vehicles comprise one or more golf cars.
